(19) United States
(12) Patent Application Publication
(10) Pub. No.: US 2011/0174745 A1
(43) Pub. Date: Jul. 21, 2011

(54) APPARATUS AND METHOD FOR SUPPLYING SLURRY FOR A SEMICONDUCTOR

(76) Inventors: Hyung Il Kim, Gyeonggi-do (KR); Sa Mun Hong, Gyeonggi-do (KR); Se Jong Ko, Gyeonggi-do (KR)

(21) Appl. No.: 13/120,149

(22) PCT Filed: Sep. 22, 2009
(86) PCT No.: PCT/KR09/05373

§ 371 Date: Mar. 21, 2011

(30) Foreign Application Priority Data
Sep. 24, 2008 (KR) 10-2008-0093708

(51) Int. Cl. B01D 24/46; B01D 35/00

(52) U.S. Cl. 210/791; 210/173

(57) ABSTRACT

Disclosed is an apparatus for supplying slurry for semiconductor, including a filter which filters slurry particles larger than a predetermined particle size; an air injector which is connected with the filter so as to back-wash the filter using compressed air injected into the filter; a slurry collecting tank which is connected with the filter so as to store the slurry filtered by the filter; and a disintegrator which is connected with the slurry collecting tank so as to crush the filtered slurry.

### CROSS REFERENCE TO RELATED APPLICATIONS

This application claims the benefit of priority to International Patent Application No. PCT/KR2009/005373 filed Sep. 22, 2009 claiming priority upon Korean Patent Application No. 10-2008-0093708 filed Sep. 24, 2008, of which full contents are incorporated herein by reference.

### TECHNICAL FIELD

The present invention relates to an apparatus for supplying slurry for semiconductor and a method thereof, and particularly, to an apparatus for supplying slurry for semiconductor and a method thereof, which can use a whole amount of an abrasive for a CMP process without waste of a residual amount thereof.

### BACKGROUND ART

Generally, in a process technology for manufacturing a semiconductor device, it is required to form finer patterns according to the requirement for high integration and high density.

Thus, the requirement for multi-layer wiring structure is gradually increased in various fields. In other words, there is a tendency that surface structure of a semiconductor device is further complicated, and also a step between interlayer films is further increased. The step between interlayer films may cause a process error.

To solve the problem, there has been various conventional methods of planarizing semiconductor wafers, such as SOG, Etch back BPSG (Boron Phosphorus Silicate Glass), Reflow and Chemical mechanical polishing (hereinafter, called “CMP”). Herein, the CMP is a process in which chemical polishing and mechanical polishing are combined with each other in order to planarize a widened surface area of a wafer as a diameter of the water is increased. Particularly, in this process, a surface of a stepped wafer is closely contacted onto a polishing pad, and then abrasive is injected between the wafer and the polishing pad so as to planarize the wafer.

The abrasive for the CMP process is a solution which is called slurry containing abrasive particles and a chemical additive. The CMP process of a semiconductor wafer is performed by using the liquid slurry. Herein, the solid fine particles contained in the suspended state in the liquid slurry which is used in the mechanical polishing should be separated within a desired range of particle size and then supplied into a CMP apparatus. If large-sized particles (e.g., typically 1μ or more in case of oxide slurry) are used in the CMP process, fine patterns formed on the semiconductor wafer may be damaged, and this leads to a defect of the semiconductor wafer.

Further, in order to use the slurry in the CMP apparatus, it is necessary to select a proper particle size according to each process property. The slurry is supplied through a slurry supplying device. The slurry supplying device supplies a suitable amount of undiluted slurry used in the CMP process, or diluted slurry mixed with an additive according to each process property. Herein, in order to properly separate the slurry particles according to its size, the slurry is generally passed through a filtering process when being supplied to the CMP apparatus.

However, the large-sized particles contained in the slurry (polishing liquid) are deposited at a bottom of a supplying container as time passes and then agglomerated together to form larger particles. Therefore, only a part of the undiluted polishing liquid is used and a residual amount thereof is trashed typically. For example, in case of the oxide slurry, 80% thereof which is located at an upper portion of the supplying container is used and the rest 20% which is at a lower portion thereof is trashed. However, since the amount of the polishing liquid which is trashed is very great, a considerable loss in money occurs. And, environment pollution becomes worse due to the trashed polishing liquid.

### Technical Problem

An object of the present invention is to provide an apparatus for supplying slurry for semiconductor and a method thereof, which can use a whole amount of abrasive for a CMP process without waste of a residual amount thereof.

### Technical Solution

To achieve the object of the present invention, the present invention provides an apparatus for supplying slurry for semiconductor, including a filter which filters slurry particles larger than a predetermined particle size; an air injector which is connected with the filter so as to back-wash the filter using compressed air injected into the filter; a slurry collecting tank which is connected with the filter so as to store the slurry filtered by the filter; and a disintegrator which is connected with the slurry collecting tank so as to crush the filtered slurry.

Preferably, the disintegrator crushes the slurry using ultrasonic waves having a high frequency.

Preferably, the filter is provided in plural so that a back washing process and a filtering process of the filters are alternately performed.

The present invention provides a method of supplying slurry for semiconductor in a slurry supplying apparatus equipped with one or more filters, wherein the slurry accumulated in a filtering member of the filter is collected by back-washing, and the slurry larger than a predetermined particle size is crushed and then supplied again to the filter.

Preferably, the filter is provided in plural so that a back washing process and a filtering process of the filters are alternately performed.

### Advantageous Effects

According to the present invention, unlike a conventional filter (unidirectional filter), the filter used in the present invention is automatically back-washed before being clogged with the slurry, and thus the filter can be used continuously for a long time period without cessation of the filtering process, thereby increasing the filtering efficiency.

Further, since the large-sized slurry particles filtered by filtering means are crushed again by using the disintegrator, it is possible to use the whole amount of the slurry without waste of a residual amount thereof. Furthermore, since the whole amount of the slurry can be used, it is possible to prevent the environment pollution due to the wasted slurry and also to reduce the cost in the CMP process.

### DESCRIPTION OF DRAWINGS

The above and other objects, features and advantages of the present invention will become apparent from the following description of preferred embodiments given in conjunction with the accompanying drawings, in which:

FIG. 1 is a schematic view of an apparatus for supplying slurry for semiconductor according to the present invention.

FIG. 2 is a view showing a process for backwashing one of filters in the apparatus for supplying slurry for semiconductor according to the present invention.

### BEST MODE

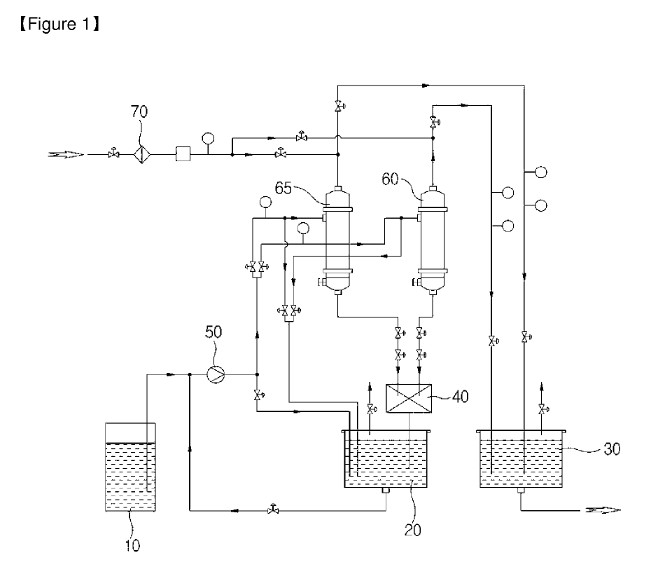

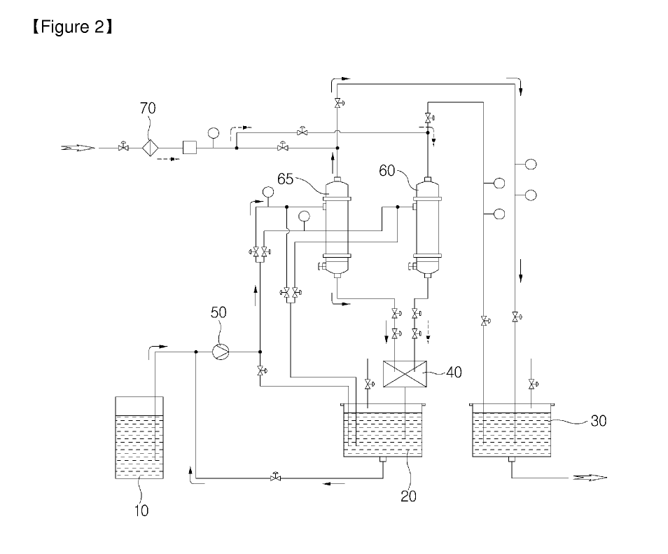

Hereinafter, the embodiments of the present invention will be described in detail with reference to accompanying drawings. FIG. 1 is a schematic view of an apparatus for supplying slurry for semiconductor according to the present invention and FIG. 2 is a view showing a process for backwashing one of filters in the apparatus for supplying slurry for semiconductor according to the present invention.

As shown in drawings, the apparatus for supplying slurry for semiconductor according to the present invention includes a slurry supplying tank 10, a filter 60, 65, a slurry collecting tank 20, an air injector 70 and a disintegrator 40.

Herein, slurry as an abrasive is supplied from the slurry supplying tank 10 and then collected in the slurry collecting tank 20. Further, the collected slurry is supplied to the filter 60, 65 by a pump 50 (or other pressing means) connected through a pipe line. Herein, the slurry may be directly supplied from the slurry supplying tank 10 to the filter 60, 65 through the pump 50.

Furthermore, the filter 60, 65 may be provided in plural. That is, the filter may include a first filter 65 and a second filter 60. The filter 60, 65 functions to remove larger slurry particles than a predetermined particle size and also to filter the usable slurry. Particularly, since the filter 60, 65 is provided in plural, it is possible to increase a recovery rate of the usable slurry. In other words, the large-sized particles larger than the predetermined particle size, which cannot pass through the filter 60, 65, are collected into the slurry collecting tank 20. The collected large-sized particles are crushed by the disintegrator 40 so as to be usable small-sized particles. The ground slurry is supplied to the filter 60, 65 so as to be filtered again. The filtering process is repeated until a filtering performance of the filter 60, 65 is deteriorated by a clogging phenomenon of the filter. Herein, the usable slurry is temporarily stored in a slurry storing tank 30 and then used in a later process.

The air injector 70 is connected to the filter 60, 65 through a pipe line so as to inject air into the filter 60, 65 in an opposite direction to a filtering direction, thereby preventing the filter 60, 65 from being clogged with the accumulated slurry. Thus, the filtering efficiency recovers. This process is called ‘backwashing’. Meanwhile, the air injected upon the backwashing is purified compressed air. It is preferable to prevent a change in physical properties of the slurry by using the purified air (e.g., nitrogen).

The disintegrator 40 is connected to each end of the filter 60, 65. Further, the disintegrator 40 functions to crush the large-sized particles filtered by the filter 60, 65, using ultrasonic waves.

Hereinafter, a method of supplying the slurry for semiconductor will be described.

As shown in FIGS. 1 and 2, the slurry which is supplied from the slurry supplying tank 10 and then received in the slurry collecting tank 20 is sucked by using the pump 50 and then supplied to the first filter 65 or the second filter 60.

The first or second filter 65, 60 are respectively connected to the pump through the pipe line branched from a supplying line of the pump 50. Herein, a valve (not designated by reference numeral) for controlling the slurry supplying may be disposed at the supplying line. Therefore, if one (for example, the second filter 60) of the operating filters 60 and 65 for filtering the slurry is clogged with the slurry and thus the filtering efficiency is deteriorated, the purified compressed air is injected into the filter (for example, the second filter 60) so as to unclog the filter, and the discharged slurry particles are supplied to the disintegrator 40. At this time, since the other (for example, the first filter 65) is normally operated, the slurry filtering process can be continuously performed without cessation.

Meanwhile, the filter 65, 60 separates the suitable and unsuitable slurry according to particle size. That is, the slurry particles (suitable slurry) smaller than the predetermined particle size are discharged into the slurry storing tank 30, and the slurry particles (unsuitable slurry) larger than the predetermined particle size are collected into the slurry collecting tank 20 and then crushed into the small-sized particles by the ultrasonic waves of the disintegrator 40. Herein, in the crushing process, it is preferable to use the ultrasonic waves having a high frequency of 1 Mhz˜3 Mhz. The slurry crushed into the small-sized particles by the disintegrator 40 is supplied again into the filter 60, 65, and the filtering process is repeated. At this time, the usable slurry particles are stored in the slurry storing tank 30. That is, the filtering process is preferably repeated until the slurry particles are crushed into the usable small-sized particles.

More detailedly, the slurry collected in the slurry collecting tank 20 is supplied to the filter 65, 60 connected to the supplying line of the slurry supplying tank 10 so as to separate the slurry. The slurry which is separated again by the filter 60, 65 may be treated once again by the crushing process. By pressure and flow rate of the slurry, it is determined whether the filter 60, 65 is clogged with the slurry. If it is determined that the filter 60, 65 is clogged with the slurry, the back washing is performed. On the other hand, the usable slurry is stored in the slurry storing tank 30 and then used in a later process.

In addition, since the filter 60, 65 is provided in plural, one of the filters 60 and 65 is back-washed and the other performs the filtering process at the same time. Even though two filters 60 and 65 are provided in FIG. 2, multiple filters may be applied. That is, two or more filters can perform the back washing process and the filtering process at the same time.

As described above, the filtering process can be performed continuously without cessation, even while the back washing process is carried out, thereby increasing the filtering efficiency.

### INDUSTRIAL APPLICABILITY

While the present invention has been described with respect to the specific embodiments, it will be apparent to those skilled in the art that various changes and modifications may be made without departing from the spirit and scope of the invention as defined in the following claims.

What is claimed is:

1. An apparatus for supplying slurry for semiconductor, comprising:
a filter which filters slurry particles larger than a predetermined particle size;
an air injector which is connected with the filter so as to back-wash the filter using compressed air injected into the filter;
a slurry collecting tank which is connected with the filter so as to store the slurry filtered by the filter; and
a disintegrator which is connected with the slurry collecting tank so as to crush the filtered slurry.

2. The apparatus according to claim 1, wherein the disintegrator crushes the slurry using ultrasonic waves having a high frequency.

3. The apparatus according to claim 1, wherein the filter is provided in plural so that a back washing process and a filtering process of the filters are alternately performed.

4. A method of supplying slurry for semiconductor in a slurry supplying apparatus equipped with one or more filters, wherein the slurry accumulated in a filtering member of the filter is separated by back-washing, and the slurry larger than a predetermined particle size is crushed and then supplied again to the filter.

5. The method according to claim 4, wherein the filter is provided in plural so that a back washing process and a filtering process of the filters are alternately performed.
